(19) United States
(12) Patent Application Publication
(10) Pub. No.: US 2014/0297949 A1
(43) Pub. Date: Oct. 2, 2014

(54) DISK ARRAY DEVICE

(71) Applicant: NEC Corporation, Tokyo (JP)

(72) Inventor: SHINTA NAKAGAWA, Tokyo (JP)

(73) Assignee: NEC Corporation, Tokyo (JP)

(21) Appl. No.: 14/224,226

(22) Filed: Mar. 25, 2014

(30) Foreign Application Priority Data
Mar. 26, 2013 (JP) 2013-063367

(51) Int. Cl. G06F 12/02; G06F 12/10

(52) U.S. Cl. CPC G06F 12/023; G06F 12/10
USPC 711/114

(57) ABSTRACT

The disk array device includes an allocation control unit that allocates a physical sector to a logical sector, and an erasure control unit that erases data written on a logical sector. The allocation control unit stores a logical sector and a physical sector allocated thereto in a translation table in association with each other, and stores allocation information representing that the physical sector is allocated to the logical sector, in an allocation table. The erasure control unit registers logical disk information specifying a logical disk, to which an erasure request has been made, in an under-erasure table, specifies a physical sector allocated to a logical sector formed in the logical disk to which the erasure request has been made, based on the allocation table and the translation table, and performs erasure processing on the specified physical sector.

### INCORPORATION BY REFERENCE

The present application is based upon and claims the benefit of priority from Japanese patent application No. 2013-063367, filed on Mar. 26, 2013, the disclosure of which is incorporated herein in its entirety by reference.

### TECHNICAL FIELD

The present invention relates to a disk array device, and in particular, to a disk array device in which a physical disk is allocated to a logical disk in response to a write request.

### BACKGROUND ART

In a magnetic storage device such as a hard disk drive, even though data is erased, there is a possibility that the data is read from the residing magnetism. As such, attention is focused on techniques called complete data erasure or sanitization. In complete data erasure, predetermined data is overwritten repeatedly in a predetermined sequence to the entire area of a magnetic storage device so as to make it impossible to read data. Although a possibility of information leakage can be reduced by these techniques, as it takes a long time to execute data erasure due to an increase in the storage capacity in recent years, reduction of the execution time is required.

Meanwhile, in a disk array device, a storage pool is constructed by integrating a plurality of physical disks such as hard disk drives by the RAID (Redundant Array of Independent Disks) technology. Further, a plurality of logical disks are configured on one storage pool so as to allow a host computer connected thereto to access the logical disks. Reading and writing from and to the logical disks are generally performed in units of sectors which are data blocks having fixed capacity. In addition to reading and writing, the host computer is able to issue various types of commands to the disk array device, in which SCSI (Small Computer System Interface) standards are widely used as standards for commands.
Patent Document 1: JP 2012-504791 A

In recent years, there is a thin provisioning technology in which a storage area on a physical disk is allocated to a logical disk at the time when writing is performed on the logical disk (see Patent Document 1, for example). With this technology, by preparing minimal physical disks at the beginning of operation, and adding a physical disk to a storage pool in line with an increase in the amount of data, the costs for construction and operation can be reduced.

In the case of complete erasure in units of physical disks, as processing cannot be performed until all logical disks on the physical disk are released, data remains for a long time, causing a security problem. As such, it is required to erase data in a short time after the operation ends, by performing complete erasure in units of logical disks.

However, even in the case of a logical disk by the thin provisioning, writing is performed multiple times on the entire area of the logical disk for complete erasure. Accordingly, as unnecessary allocations of physical disk areas and writing are caused a large number of times, it takes time for processing.

### SUMMARY

As such, an exemplary object of the present invention is to solve the above-described problem, that is, a problem that it takes time to perform complete erasure on a logical disk.

A disk array device, which is an exemplary aspect of the present invention, includes

an allocation control unit that in response to a write request with respect to a logical disk, allocates a physical sector, which is a storage area of a physical disk, to a logical sector formed in the logical disk; and

an erasure control unit that in response to a data erasure instruction with respect to a logical disk, erases data written on a logical sector formed in the logical disk.

The allocation control unit stores logical sector information specifying a logical sector and physical sector information specifying a physical sector allocated to the logical sector, in a translation table in association with each other, and stores allocation information representing that the physical sector is allocated to the logical sector, in an allocation table in association with the logical sector information.

The erasure control unit registers logical disk information specifying a logical disk, to which an erasure request has been made, in an under-erasure table, specifies a physical sector allocated to a logical sector formed in the logical disk to which the erasure request has been made, based on the allocation table and the translation table, and performs erasure processing on the specified physical sector.

Further, a program, which is another exemplary aspect of the present invention, is a program for causing a disk array device to realize:

an allocation control unit that in response to a write request with respect to a logical disk, allocates a physical sector, which is a storage area of a physical disk, to a logical sector formed in the logical disk; and

an erasure control unit that in response to a data erasure instruction with respect to a logical disk, erases data written on a logical sector formed in the logical disk, wherein

the allocation control unit stores logical sector information specifying a logical sector and physical sector information specifying a physical sector allocated to the logical sector, in a translation table in association with each other, and stores allocation information representing that the physical sector is allocated to the logical sector, in an allocation table in association with the logical sector information, and

the erasure control unit registers logical disk information specifying a logical disk, to which an erasure request has been made, in an under-erasure table, specifies a physical sector allocated to a logical sector formed in the logical disk to which the erasure request has been made, based on the allocation table and the translation table, and performs erasure processing on the specified physical sector.

Further, a disk array control method, which is another exemplary aspect of the present invention, is configured to include

in response to a write request with respect to a logical disk, when allocating a physical sector, which is a storage area of a physical disk, to a logical sector formed in the logical disk, storing logical sector information specifying the logical sector and physical sector information specifying the physical sector allocated to the logical sector, in a translation table in association with each other, and storing allocation information representing that the physical sector is allocated to the logical sector, in an allocation table in association with the logical sector information; and

in response to a data erasure instruction with respect to a logical disk, when erasing data written on a logical sector formed in the logical disk, registering logical disk information specifying the logical disk, to which an erasure request has been made, in an under-erasure table, specifying a physical sector allocated to the logical sector formed in the logical disk to which the erasure request has been made, based on the allocation table and the translation table, and performing erasure processing on the specified physical sector.

With the configuration described above, the present invention is able to realize complete erasure to be performed at a higher speed on a logical disk.

### BRIEF DESCRIPTION OF DRAWINGS

FIG. 1 is a block diagram showing a configuration of a disk array device according to a first exemplary embodiment of the present invention;

FIG. 2 is a diagram showing exemplary data stored in the disk array device disclosed in FIG. 1;

FIG. 3 is a diagram showing exemplary data stored in the disk array device disclosed in FIG. 1;

FIG. 4A is a flowchart showing operation of the disk array device disclosed in FIG. 1;

FIG. 4B is a flowchart showing operation of the disk array device disclosed in FIG. 1;

FIG. 4C is a flowchart showing operation of the disk array device disclosed in FIG. 1;

FIG. 5 is a flowchart showing operation of the disk array device disclosed in FIG. 1;

FIG. 6 is a flowchart showing operation of the disk array device disclosed in FIG. 1;

FIG. 7 is a flowchart showing operation of the disk array device disclosed in FIG. 1; and

FIG. 8 is a block diagram showing another exemplary configuration of the disk array device according to the first exemplary embodiment of the present invention.

### EXEMPLARY EMBODIMENTS

### First Exemplary Embodiment

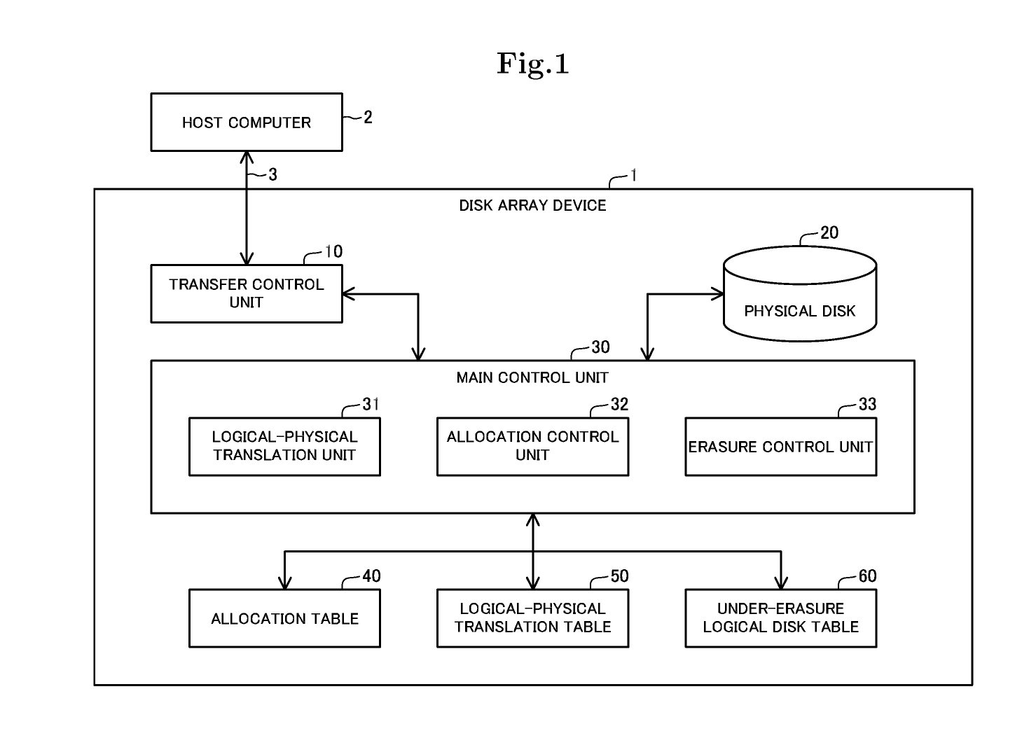

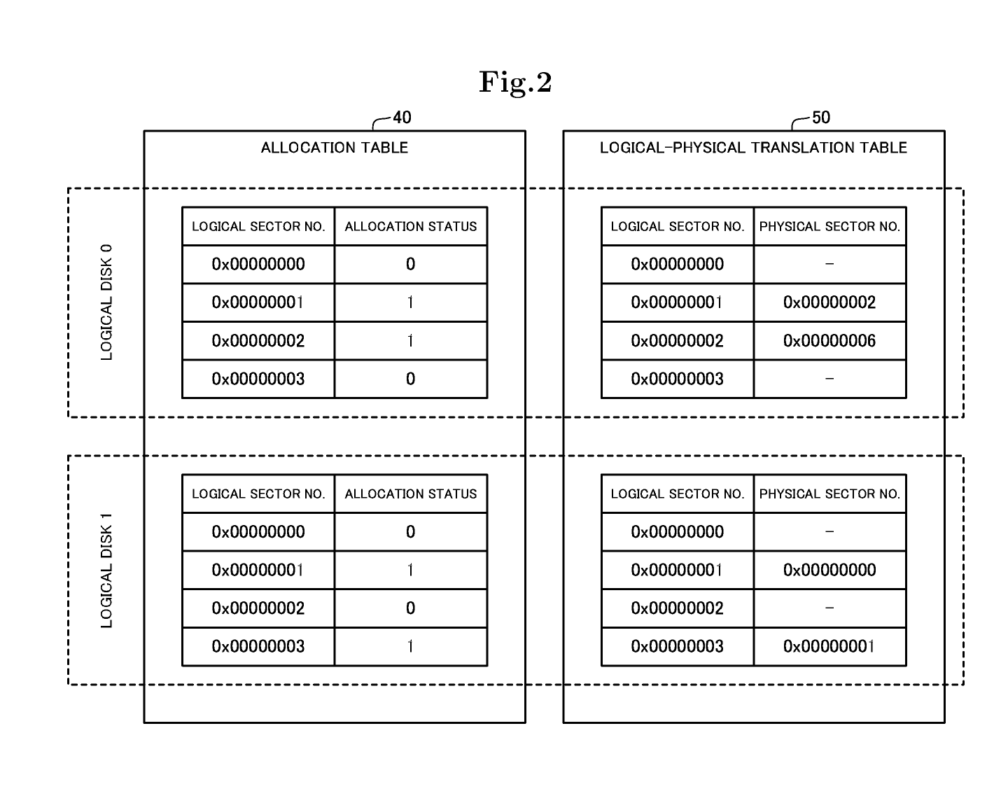

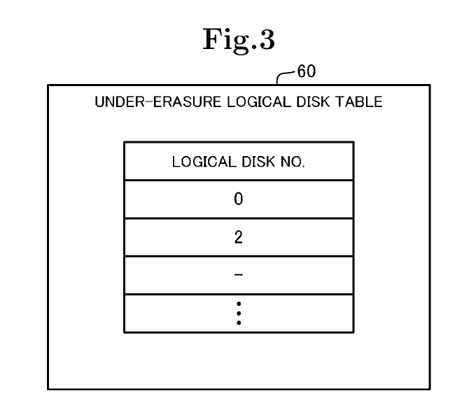

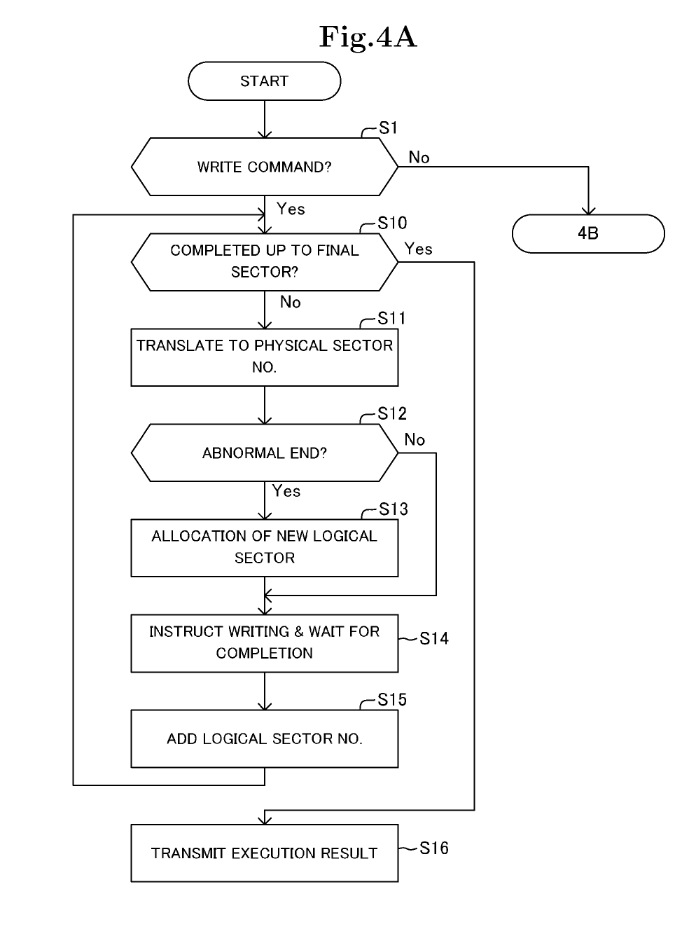

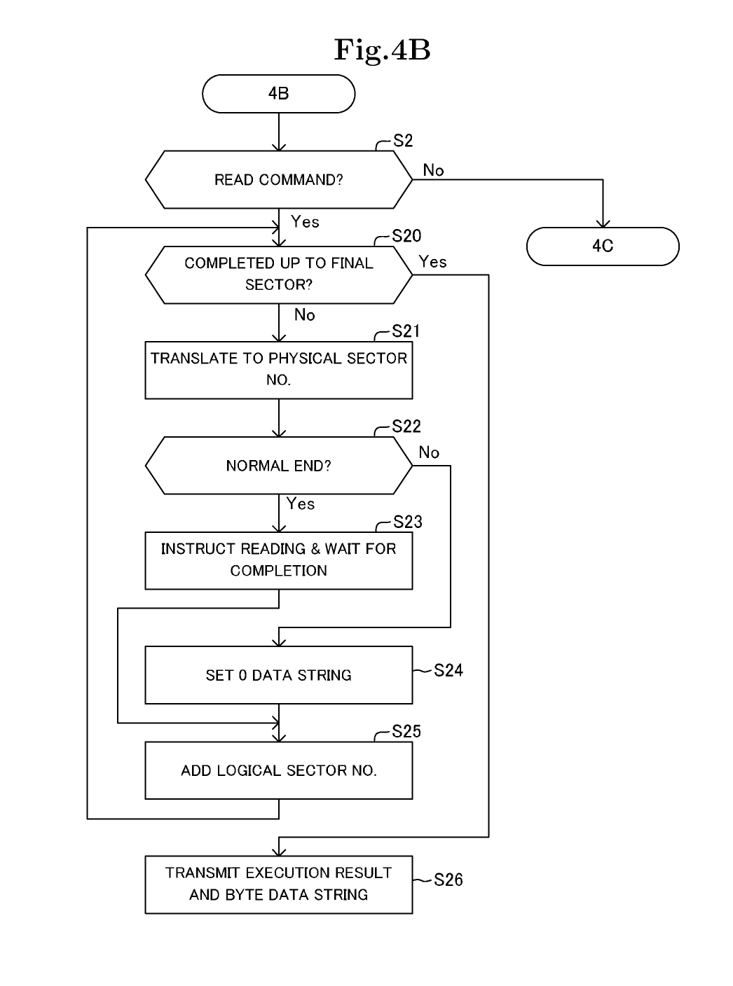

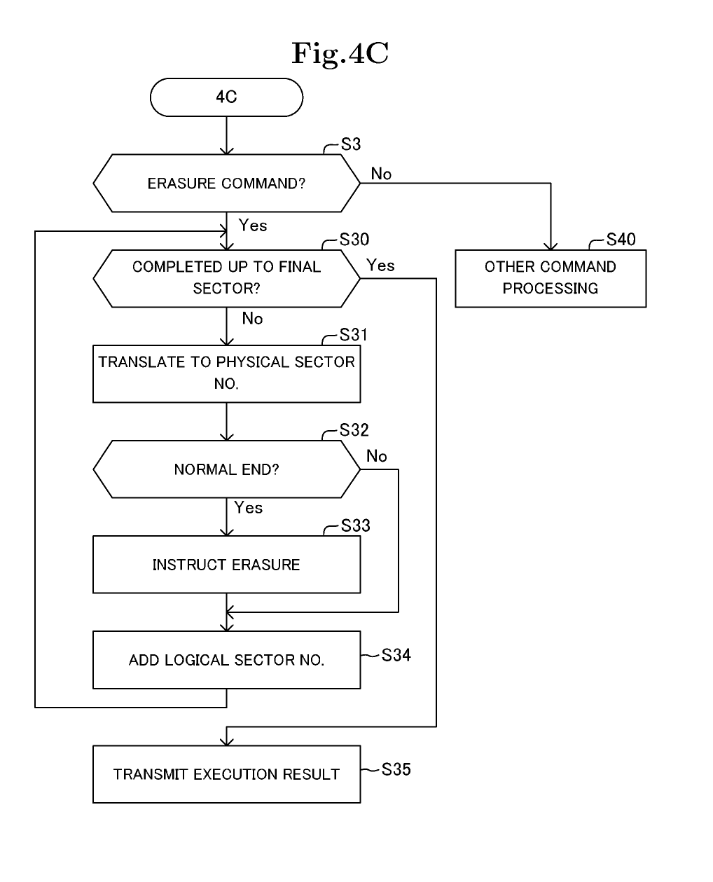

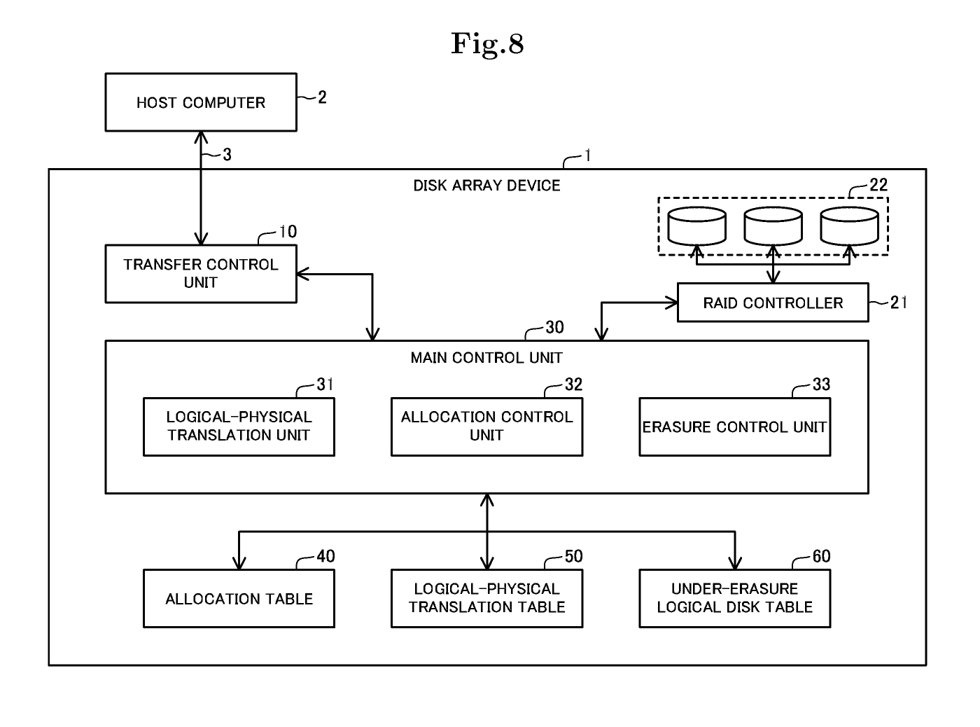

A first exemplary embodiment of the present invention will be described with reference to FIGS. 1 to 8. FIG. 1 is a block diagram showing a configuration of a disk array device. FIGS. 2 and 3 show exemplary data stored in the disk array device. FIGS. 4A to 7 are flowcharts showing the operation of the disk array device. FIG. 8 is a block diagram showing another exemplary configuration of a disk array device.

### [Configuration]

As shown in FIG. 1, a disk array device 1 according to the present embodiment is connected with a host computer 2 via an interface 3. The disk array device 1 includes a transfer control unit 10, a physical disk 20, and a main control unit 30. The interface 3 is connected with the transfer control unit 10, the transfer control unit 10 is connected with the main control unit 30, and the main control unit 30 is connected with the physical disk 20. It should be noted that the transfer control unit 10 and the main control unit 30 are implemented by a program being installed in a central processing unit provided in the disk array device 1.

The transfer control unit 10 receives commands including write commands, read commands, and erase commands, from the host computer 2. Then, the transfer control unit 10 transmits the command to the main control unit 30, and waits for completion of processing by the main control unit 30. Further, after completion of the processing by the main control unit 30, the transfer control unit 10 receives an execution result of the command and a byte data string from the main control unit 30, and transmits the execution result and the byte data string to the host computer 2.

Here, the write command includes a logical disk number, a logical sector number, a data length, and a byte data string. The transfer control unit 10 transfers the write command to the main control unit 30, waits for completion of processing by the main control unit 30, and after completion, transmits an execution result, received from the main control unit 30, to the host computer 2.

The read command includes a logical disk number, a logical sector number, and a data length. The transfer control unit 10 transmits the read command to the main control unit 30, waits for completion of processing by the main control unit 30, and after completion, transmits a byte data string, received from the main control unit 30, to the host computer 2.

The erase command includes a logical disk number, a logical sector number, and a data length. The transfer control unit 10 transfers the erase command to the main control unit 30, waits for completion of processing by the main control unit 30, and after completion, transmits an execution result, received from the main control unit 30, to the host computer 2.

The physical disk 20 is a magnetic storage device which stores byte data in units of physical sectors, and processes write instructions and read instructions received from the main control unit 30. The write instruction includes a physical sector number and a byte data string. The physical disk 20 writes the byte data string to the physical sector, and after completion of the processing, transmits an execution result to the main control unit 30. The read instruction includes a physical sector number. The physical disk 20 reads a byte data string from the physical sector, and after completion of the processing, transmits the byte data string to the main control unit 30.

As shown in FIG. 1, the main control unit 30 includes a logical-physical translation unit 31, an allocation control unit 32, and an erasure control unit 33, and processes commands received from the transfer control unit 10. The main control unit 30 performs translation to physical sector numbers by the logical-physical translation unit 31 on logical sectors of the number converted from the data length included in the command starting from the logical sector number included in the command, and performs processing corresponding to each command. After completion of the processing performed on all of the logical sectors, the main control unit 30 transmits execution results and byte data strings to the transfer control unit 10.

Specifically, as to the write command, the main control unit 30 performs an allocation instruction of a physical sector to the allocation control unit 32, transmission of a write instruction to the physical disk 20, and a wait for completion of processing by the physical disk 20. As to the read command, the main control unit 30 performs transmission of a read instruction to the physical disk 20, a wait for completion of processing by the physical disk 20. As to the erase command, the main control unit 30 performs erasure instruction to the erasure control unit 33.

The logical-physical translation unit 31 uses an allocation table 40 and a logical-physical translation table 50, which will be described below, to perform translation from a logical disk number and a logical sector number to a physical sector number assigned to the logical sector. It should be noted that if a physical sector is not allocated to the logical sector, the logical-physical translation unit 31 returns an invalid value.

The allocation control unit 32 uses the allocation table 40, the logical-physical translation table 50, and an under-erasure logical disk table 60, which will be described below, to allocate a physical sector to a logical sector on a logical disk. Here, when newly allocating a physical sector to a logical sector in response to a write request as described below, if there is any physical sector being erased, the allocation control unit 32 instructs the erasure control unit 33 to terminate the erasure processing, and allocates the physical sector being erased to the logical sector. On the other hand, if there is no physical sector being erased, the allocation control unit 32 allocates an unused physical sector to the logical sector. Then, the allocation control unit 32 returns the allocated physical sector number.

The erasure control unit 33 performs complete erasure on a physical sector by writing predetermined byte data in a predetermined sequence to the physical sector based on regulations of some kind. The erasure control unit 33 repeatedly transmits a write instruction to the physical disk 20 until the processing based on the regulations has been completed, and waits for completion of the processing by the physical disk 20. After completion of the entire processing, the erasure control unit 33 returns normal end. However, if an instruction to terminate the erasure is given to the physical sector as described below, the erasure control unit 33 terminates the processing when the write instruction under execution is completed, and returns execution termination.

In the example described above, commands transmitted by the host computer 2 are SCSI (Small Computer System Interface) commands, for example. However, the type of commands is not limited to this, if necessary information can be transmitted. Further, while a specific configuration of the magnetic storage device 20 is a hard disk drive, for example, the device may be a storage volume configured of a plurality of hard disk drives and RAID (Redundant Arrays of Inexpensive Disks) controllers, if read and write instructions can be made in units of sectors and write positions on a physical medium are fixed by the respective sector numbers included in the instructions.

Further, as for conversion from a data length to the number of sectors by the main control unit 30, while there is a method of dividing the data length by 512 based on an assumption that one sector is 512 bytes, the length may be converted by using another value such as one sector being 4096 bytes. Further, while the regulation of complete erasure processing is a United States Department of Defense-compliant method, for example, any method can be used if erasure processing is performed by multiple writing.

Next, detailed configurations of the allocation table 40, the logical-physical translation table 50, and the under-erasure logical disk table 60 will be described. These tables 40, 50, and 60 are formed on storage units such as a RAM and ROM and the physical disk 20 provided in the disk array device 1.

FIG. 2 shows exemplary configurations of the allocation table 40 and the logical-physical translation table 50. As shown by dotted lines in FIG. 2, the allocation table 40 and the logical-physical translation table 50 are provided for each logical disk. In the allocation table 40, for each of the logical sectors on each logical disk, allocation status information representing presence or absence of allocation of a physical sector in 1 bit, is stored. Specifically, the allocation control unit 32 stores “1” if a physical sector is allocated while stores “0” if a physical sector is not allocated, as allocation status information (allocation information) in the bit in association with a logical sector number (logical sector information) specifying the logical sector.

Further, in the logical-physical translation table 50 (translation table), if a physical sector is allocated to each of the logical sectors on each logical disk, a physical sector number is stored in the entry corresponding to the logical sector. Specifically, the allocation control unit 32 stores a physical sector number (physical sector information) specifying the allocated physical sector in association with the logical sector number (logical sector information) specifying the logical sector.

Further, FIG. 3 shows an exemplary configuration of the under-erasure logical disk table 60. In the under-erasure logical disk table 60, the erasure control unit 33 stores a logical disk number (logical disk information) specifying the logical disk on which erasure processing is in progress.

### [Operation]

Next, operation of the disk array device 1 will be described. First, operation of the main control unit 30 shown in FIG. 1 will be described using the flowcharts of FIGS. 4A, 4B, and 4C.

First, the main control unit 30 branches the processing in accordance with a received command (step S1 in FIG. 4A, step S2 in FIG. 4B, and step S3 in FIG. 4C).

If the received command is a write command (step S1 in FIG. 4A: Yes), the main control unit 30 repeats the following processing, starting from the logical sector number included in the write command up to the final logical sector by adding logical sector numbers (steps S10 to S15). To be specific, from the logical disk number and the processing-target logical sector number included in the write command, the main control unit 30 translates the logical sector number to a physical sector number by the logical-physical translation unit 31 (step S11).

In this step, if translation ends abnormally because a physical sector number corresponding to the logical sector number is not registered, for example (step S12: Yes), a new physical sector is allocated to the logical sector on the logical disk by the allocation control unit 32 (step S13). It should be noted that the allocation control unit 32 registers numbers of a logical sector and a physical sector in association with each other in the logical-physical translation table 50, and sets “1” to the bit of the logical sector to which the physical sector is allocated, as described below. Allocation processing by the allocation control unit 32 will be described below.

Then, the main control unit 30 transmits a write instruction, including the physical sector number and a byte data string within the range corresponding to the logical sector, among the byte data strings included in the write command, to the physical disk 20, and waits for completion of the processing by the physical disk 20 (step S14). Then, the main control unit 30 performs the above-described processing on all of the logical sectors (step S15), and after completion of the processing, transmits an execution result to the transfer control unit 10 (step S16).

Meanwhile, if the received command is a read command (step S2 in FIG. 4B: Yes), the main control unit 30 repeats the following processing, starting from the logical sector number included in the read command up to the final logical sector by adding logical sector numbers (steps S20 to S25). First, the main control unit 30 performs translation from the logical disk number and the processing-target logical sector number included in the read command to a physical sector number, by the logical-physical translation unit 31 (step S21).

If translation from the logical sector number to the physical sector number ends normally (step S22: Yes), the main control unit 30 transmits a read instruction including the physical sector number to the physical disk 20, and waits for completion of the processing by the physical disk 20 (step S23). If the translation ends abnormally (step S22: No), the main control unit 30 generates a byte data string in which every byte value is 0 (step S24).

Then, after completion of the processing performed on all of the logical sectors, the main control unit 30 transmits an execution result and read or generated byte data strings to the transfer control unit 10.

Meanwhile, if the received command is an erase command (step S3 in FIG. 4C: Yes), the main control unit 30 repeats the following processing, starting from the logical sector number included in the erase command up to the final logical sector by adding logical sector numbers (steps S30 to S34). First, the main control unit 30 performs translation from the logical disk number and the processing-target logical sector number included in the erase command to a physical sector number, by the logical-physical translation unit 31 (step S31).

If translation of the logical sector number ends normally (step S32: Yes), the main control unit 30 instructs erasure, including the logical disk number and the physical sector number, to the erasure control unit 33 (step S33). Then, after completion of the processing performed on all of the sectors, the main control unit 30 transmits an execution result to the transfer control unit 10 (step S35). It should be noted that erasure processing by the erasure control unit 33 will be described below.

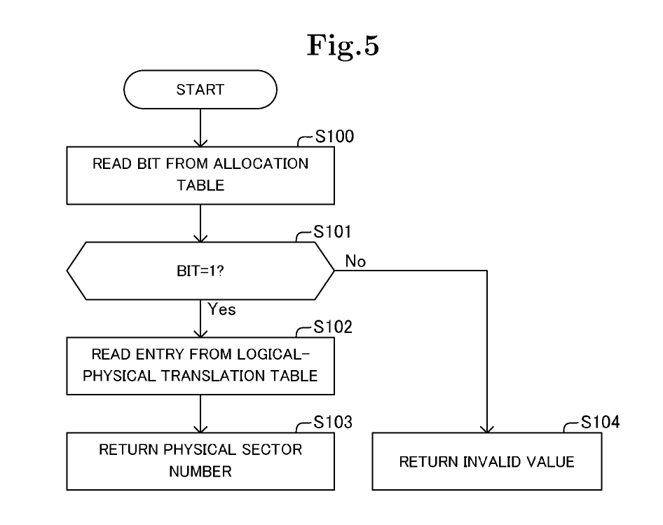

Next, operation of the logical-physical translation unit 31 will be described using the flowchart of FIG. 5. From an allocation table of a processing-target logical disk in the allocation table 40, the logical-physical translation unit 31 reads out the bit storing the allocation status of a processing-target logical sector (step S100).

If the bit value of the processing-target logical sector, read out from the allocation table 40, is “1” (step S101: Yes), the logical-physical translation unit 31 reads an entry corresponding to the processing-target logical sector from the logical-physical translation table of the processing-target logical disk in the logical-physical translation table 50 (step S102). Then, the logical-physical translation unit 31 reads the physical sector number allocated to the processing-target logical sector from the entry, and returns the physical sector number (step S103). On the other hand, if the bit value of the logical sector read out from the allocation table 40 is “0” (step S101: No), the logical-physical translation unit 31 returns an invalid value (step S104).

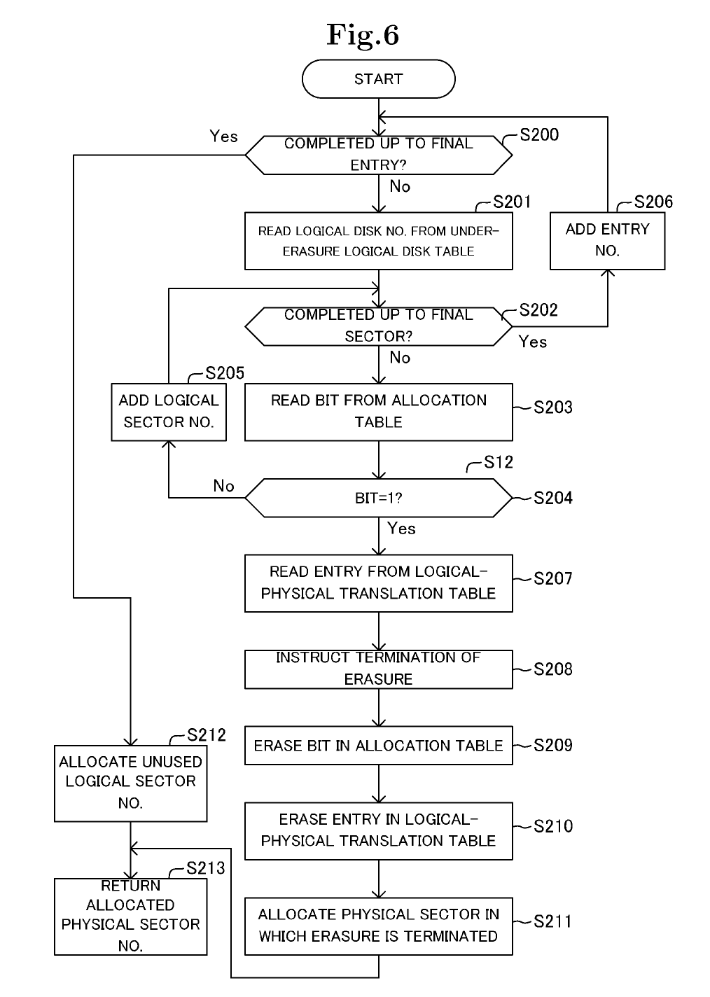

Next, operation of the allocation control unit 32 will be described using the flowchart of FIG. 6. The allocation control unit 32 operates as follows when an allocation instruction is given from the main control unit 30 in response to a write request from the host computer 2.

First, as for the under-erasure logical disk table 60, the allocation control unit 32 repeats the following processing, starting from the 0^{th} entry up to the final entry by adding entry numbers (steps S200 to S206). Then, the allocation control unit 32 reads the under-erasure logical disk number, from the processing-target entry in the under-erasure logical disk table 60 (step S201).

Then, as for the allocation table corresponding to the under-erasure logical disk number in the allocation table 40, the allocation control unit 32 repeats the following processing, starting from the 0^{th} under-erasure logical sector up to the final under-erasure logical sector, by adding logical sector numbers (steps S202 to S205). To be specific, the allocation control unit 32 reads the bit storing the allocation status of the under-erasure logical sector from the allocation table of the under-erasure logical disk (step S203). If the bit value is “0”, the allocation control unit 32 adds a logical sector number (step S205) and returns to step S202.

If the bit value of the allocation status of the under-erasure logical sector is “1” (step S204: Yes), the allocation control unit 32 reads the entry corresponding to the under-erasure logical sector from the logical-physical translation table of the processing-target under-erasure logical disk in the logical-physical translation table 50 (step S207). Next, the allocation control unit 32 reads the number of the physical sector allocated to the under-erasure logical sector from the entry corresponding to the under-erasure logical sector, and instructs the erasure control unit 33 to terminate erasure of the physical sector (step S208).

Then, the allocation control unit 32 erases the bit storing the allocation status of the under-erasure logical sector from the allocation table 40 of the under-erasure logical disk (step S209). In addition, the allocation control unit 32 erases the entry corresponding to the under-erasure logical sector from the logical-physical translation table 50 of the under-erasure logical disk (step S210).

Further, the allocation control unit 32 registers the number of the under-erasure physical sector in the entry corresponding to the allocation-target logical sector, on the logical-physical translation table of the allocation-target logical disk in the logical-physical translation table 50. Further, the allocation control unit 32 sets “1” to the bit storing the allocation status of the allocation-target logical sector, on the allocation table of the allocation-target logical disk in the allocation table 40 (step S211).

On the other hand, if processing has been performed up to the final under-erasure logical sector at step S202, the allocation control unit 32 adds the entry number (step S206) and returns to step S200.

Further, if processing has been performed up to the final entry at step S200 (step S200: Yes), the allocation control unit 32 registers the number of an unused physical sector in the entry corresponding to the allocation-target logical sector, on the logical-physical translation table of the allocation-target logical disk, in the logical-physical translation table 50 (step S212). Then, the allocation control unit 32 sets “1” to the bit storing the allocation status of the allocation-target logical sector, on the allocation table of the allocation-target logical disk in the allocation table 40.

After the processing described above, the allocation control unit 32 returns the physical sector number allocated to the allocation-target logical sector (step S213).

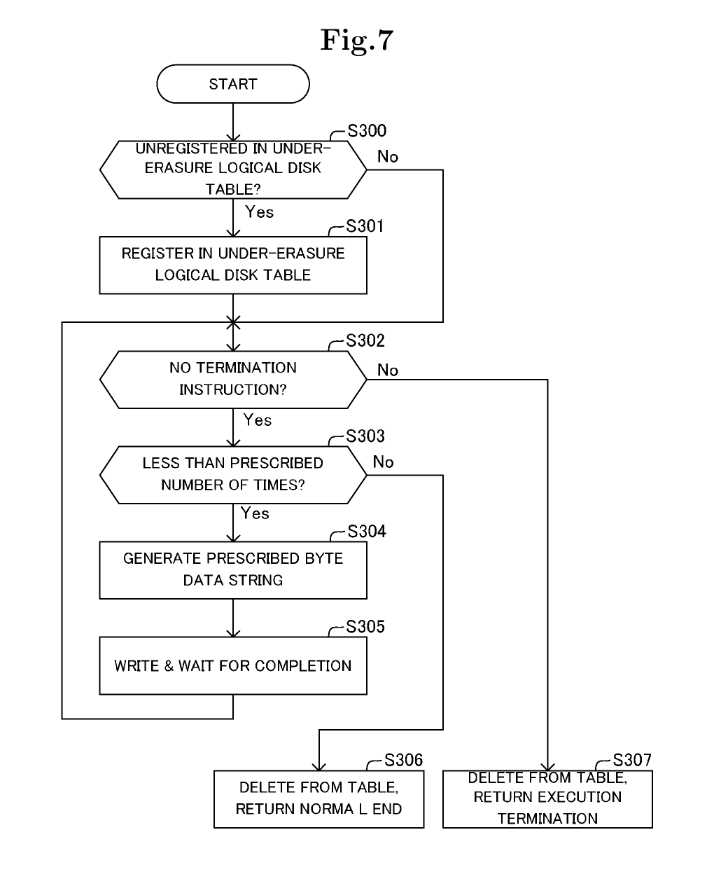

Next, operation of the erasure control unit 33 will be described using the flowchart of FIG. 7. If a target logical disk number is not registered in the under-erasure logical disk table 60 (step S300: Yes), the erasure control unit 33 registers the logical disk number in the under-erasure logical disk table 60 (step S301). Then, the erasure control unit 33 repeatedly performs the following processing on the target physical sector (steps S302 to S305).

First, at the time of each processing cycle (step S302: Yes, step S303: Yes), the erasure control unit 33 generates a byte data string for erasure in order to write it onto the physical disk 20 (step S304). Then, the erasure control unit 33 transmits a write instruction configured of the physical sector number and the byte data string to the physical disk 20, and waits for completion of processing by the physical disk 20 (step S305). After completion of the processing, the erasure control unit 33 returns to step S302.

When the erasure control unit 33 receives a termination instruction with respect to a physical sector from the allocation control unit 32 (step S302: No), the erasure control unit 33 deletes the logical disk number in which the erasure processing is in progress from the under-erasure logical disk table 60, and returns execution termination (step S307). On the other hand, if the number of times of the erasure processing reaches the prescribed number of times (step S303: No), the erasure control unit 33 deletes the logical disk number in which the erasure processing is in progress from the under-erasure logical disk table 60, and returns normal end (step S306).

It should be noted that while an invalid value returned by the logical-physical translation unit 31 in the embodiment described above is, for example, a physical sector number in a range exceeding the storage capacity of the physical disk 20 such as “0xFFFFFFFF”, it is not limited to this value.

As described above, according to the present invention, when deleting a logical disk, erasure processing is performed only on the area (physical sector) of the physical disk allocated to the logical disk due to writing of data, with reference to the allocation table 40 and the logical-physical translation table 50. Thereby, it is possible to reduce the number of processing and to realize complete erasure at a higher speed, compared with the case of performing erasure processing on the entire area of the logical disk and the physical disk.

Further, when a physical sector is allocated to a logical sector which is used as a new writing target in response to a write request, a physical sector in which erasure processing is in progress is selected in preference, with reference to the under-erasure logical disk table 60, the allocation table 40, and the logical-physical translation table 50. Then, the erasure processing performed on the selected physical sector is terminated, and the physical sector is allocated to the logical sector which becomes as a new writing target. Thereby, the number of executions of erasure processing can be further reduced.

Next, another configuration of the present invention will be described with reference to FIG. 8. As shown in FIG. 8, the disk array device 1 includes a RAID controller 21 connected between the main control unit 30 and a physical disk 22. The main control unit 30 performs the same processing as that described above on the RAID controller 21, rather than the above-described physical disk 20 shown in FIG. 1.

The RAID controller 21 performs translation from a physical sector number included in a write command and a read command received from the main control unit 30, to a sector number on the physical disk which stores byte data of the physical sector on each physical disk 22, and performs reading and writing on each physical disk 22. When writing, the RAID controller 21 also performs writing to a plurality of physical disks, and writing of parity data to a physical disk for storing parity of the written data, depending on the RAID types.

With this configuration, the present invention is also applicable to logical disks constructed on a storage pool by RAID.

### <Supplementary Notes>

The whole or part of the exemplary embodiments disclosed above can be described as, but not limited to, the following supplementary notes. Hereinafter, the outlines of the configurations of a disk array device, a program, and a disk array control method will be described. However, the present invention is not limited to the configurations described below.

### (Supplementary Note 1)

A disk array device comprising:

an allocation control unit that in response to a write request with respect to a logical disk, allocates a physical sector to a logical sector formed in the logical disk, the physical sector being a storage area of a physical disk; and

an erasure control unit that in response to a data erasure instruction with respect to a logical disk, erases data written on a logical sector formed in the logical disk, wherein

the allocation control unit stores logical sector information specifying a logical sector and physical sector information specifying a physical sector allocated to the logical sector, in a translation table in association with each other, and stores allocation information representing that the physical sector is allocated to the logical sector, in an allocation table in association with the logical sector information, and

the erasure control unit registers logical disk information specifying a logical disk, to which an erasure request has been made, in an under-erasure table, specifies a physical sector allocated to a logical sector formed in the logical disk to which the erasure request has been made, based on the allocation table and the translation table, and performs erasure processing on the specified physical sector.

### (Supplementary Note 2)

The disk array device according to supplementary note 1, wherein

in response to the write request with respect to the logical disk, the allocation control unit specifies a logical disk registered in the under-erasure table, specifies a physical sector allocated to a logical sector in the logical disk based on the allocation table and the translation table, and allocates the specified physical sector to a logical sector which becomes a new writing target area in response to the write request.

### (Supplementary Note 3)

The disk array device according to supplementary note 2, wherein

in response to the write request with respect to the logical disk, the allocation control unit specifies the logical disk registered in the under-erasure table, instructs the erasure control unit to terminate erasure processing performed on the logical disk, and allocates the physical sector allocated to the logical sector in the logical disk, to the logical sector which becomes a new writing target area in response to the write request.

### (Supplementary Note 4)

The disk array device according to supplementary note 3, wherein

in response to the write request with respect to the logical disk, the allocation control unit terminates erasure processing performed on the physical sector allocated to the logical sector in the logical disk registered in the under-erasure table, and allocates the physical sector to the logical sector which becomes a new writing target area in response to the write request.

### (Supplementary Note 5)

The disk array device according to supplementary note 4, wherein

the allocation control unit deletes the physical sector information and the allocation information associated with the logical sector information of the logical sector to which the physical sector, in which the erasure processing has been terminated, is allocated, from the translation table and the allocation table, respectively, and stores the logical sector information of the logical sector which is newly allocated to the physical sector, in association with the physical sector information and the allocation information of the physical sector, in the translation table and the allocation table.

### (Supplementary Note 6)

The disk array device according to any of supplementary notes 1 to 5, wherein

the erasure control unit performs erasure processing only on a physical sector corresponding to the logical sector formed in the logical disk to which the erasure request has been made, based on the allocation table and the translation table.

### (Supplementary Note 7)

A program for causing a disk array device to realize:

an allocation control unit that in response to a write request with respect to a logical disk, allocates a physical sector to a logical sector formed in the logical disk, the physical sector being a storage area of a physical disk, and

an erasure control unit that in response to a data erasure instruction with respect to a logical disk, erases data written on a logical sector formed in the logical disk, wherein

the allocation control unit stores logical sector information specifying a logical sector and physical sector information specifying a physical sector allocated to the logical sector, in a translation table in association with each other, and stores allocation information representing that the physical sector is allocated to the logical sector, in an allocation table in association with the logical sector information, and

the erasure control unit registers logical disk information specifying a logical disk, to which an erasure request has been made, in an under-erasure table, specifies a physical sector allocated to a logical sector formed in the logical disk to which the erasure request has been made, based on the allocation table and the translation table, and performs erasure processing on the specified physical sector.

### (Supplementary Note 8)

The program according to supplementary note 7, wherein

in response to the write request with respect to the logical disk, the allocation control unit specifies a logical disk registered in the under-erasure table, specifies a physical sector allocated to a logical sector in the logical disk based on the allocation table and the translation table, and allocates the specified physical sector to a logical sector which becomes a new writing target area in response to the write request.

### (Supplementary Note 9)

A disk array control method comprising:

in response to a write request with respect to a logical disk, when allocating a physical sector to a logical sector formed in the logical disk, the physical sector being a storage area of a physical disk, storing logical sector information specifying the logical sector and physical sector information specifying the physical sector allocated to the logical sector, in a translation table in association with each other, and storing allocation information representing that the physical sector is allocated to the logical sector, in an allocation table in association with the logical sector information; and

in response to a data erasure instruction with respect to a logical disk, when erasing data written on a logical sector formed in the logical disk, registering logical disk information specifying the logical disk, to which an erasure request has been made, in an under-erasure table, specifying a physical sector allocated to the logical sector formed in the logical disk to which the erasure request has been made, based on the allocation table and the translation table, and performing erasure processing on the specified physical sector.

### (Supplementary Note 10)

The disk array control method according to supplementary note 9, wherein

in response to the write request with respect to the logical disk, specifying a logical disk registered in the under-erasure table, specifying a physical sector allocated to the logical sector in the logical disk based on the allocation table and the translation table, and allocating the specified physical sector to a logical sector which becomes a new writing target area in response to the write request.

It should be noted that the program described above is stored in a storage device or on a computer-readable storing medium. For example, a storage medium is a portable medium such as a flexible disk, an optical disk, a magneto-optical disk, a semiconductor memory, or the like.

While the present invention has been described with reference to the exemplary embodiments described above, the present invention is not limited to the above-described embodiments. The form and details of the present invention can be changed within the scope of the present invention in various manners that can be understood by those skilled in the art.

1. A disk array device comprising:
an allocation control unit that in response to a write request with respect to a logical disk, allocates a physical sector to a logical sector formed in the logical disk, the physical sector being a storage area of a physical disk; and
an erasure control unit that in response to a data erasure instruction with respect to a logical disk, erases data written on a logical sector formed in the logical disk, wherein
the allocation control unit stores logical sector information specifying a logical sector and physical sector information specifying a physical sector allocated to the logical sector, in a translation table in association with each other, and stores allocation information representing that the physical sector is allocated to the logical sector, in an allocation table in association with the logical sector information, and
the erasure control unit registers logical disk information specifying a logical disk, to which an erasure request has been made, in an under-erasure table, specifies a physical sector allocated to a logical sector formed in the logical disk to which the erasure request has been made, based on the allocation table and the translation table, and performs erasure processing on the specified physical sector.

2. The disk array device according to claim 1, wherein
in response to the write request with respect to the logical disk, the allocation control unit specifies a logical disk registered in the under-erasure table, specifies a physical sector allocated to a logical sector in the logical disk based on the allocation table and the translation table, and allocates the specified physical sector to a logical sector which becomes a new writing target area in response to the write request.

3. The disk array device according to claim 2, wherein
in response to the write request with respect to the logical disk, the allocation control unit specifies the logical disk registered in the under-erasure table, instructs the erasure control unit to terminate erasure processing performed on the logical disk, and allocates the physical sector allocated to the logical sector in the logical disk, to the logical sector which becomes a new writing target area in response to the write request.

4. The disk array device according to claim 3, wherein
in response to the write request with respect to the logical disk, the allocation control unit terminates erasure processing performed on the physical sector allocated to the logical sector in the logical disk registered in the under-erasure table, and allocates the physical sector to the logical sector which becomes a new writing target area in response to the write request.

5. The disk array device according to claim 4, wherein
the allocation control unit deletes the physical sector information and the allocation information associated with the logical sector information of the logical sector to which the physical sector, in which the erasure processing has been terminated, is allocated, from the translation table and the allocation table, respectively, and stores the logical sector information of the logical sector which is newly allocated to the physical sector, in association with the physical sector information and the allocation information of the physical sector, in the translation table and the allocation table.

6. The disk array device according to claim 1, wherein
the erasure control unit performs erasure processing only on a physical sector corresponding to the logical sector formed in the logical disk to which the erasure request has been made, based on the allocation table and the translation table.

7. A non-transitory computer-readable medium storing a program comprising instructions for causing a disk array device to realize:
an allocation control unit that in response to a write request with respect to a logical disk, allocates a physical sector to a logical sector formed in the logical disk, the physical sector being a storage area of a physical disk; and
an erasure control unit that in response to a data erasure instruction with respect to a logical disk, erases data written on a logical sector formed in the logical disk, wherein
the allocation control unit stores logical sector information specifying a logical sector and physical sector information specifying a physical sector allocated to the logical sector, in a translation table in association with each other, and stores allocation information representing that the physical sector is allocated to the logical sector, in an allocation table in association with the logical sector information, and
the erasure control unit registers logical disk information specifying a logical disk, to which an erasure request has been made, in an under-erasure table, specifies a physical sector allocated to a logical sector formed in the logical disk to which the erasure request has been made, based on the allocation table and the translation table, and performs erasure processing on the specified physical sector.

8. The non-transitory computer-readable medium storing a program according to claim 7, wherein
in response to the write request with respect to the logical disk, the allocation control unit specifies a logical disk registered in the under-erasure table, specifies a physical sector allocated to a logical sector in the logical disk based on the allocation table and the translation table, and allocates the specified physical sector to a logical sector which becomes a new writing target area in response to the write request.

9. A disk array control method comprising:
in response to a write request with respect to a logical disk, when allocating a physical sector to a logical sector formed in the logical disk, the physical sector being a storage area of a physical disk, storing logical sector information specifying the logical sector and physical sector information specifying the physical sector allocated to the logical sector, in a translation table in association with each other, and storing allocation information representing that the physical sector is allocated to the logical sector, in an allocation table in association with the logical sector information; and
in response to a data erasure instruction with respect to a logical disk, when erasing data written on a logical sector formed in the logical disk, registering logical disk information specifying the logical disk, to which an erasure request has been made, in an under-erasure table, specifying a physical sector allocated to the logical sector formed in the logical disk to which the erasure request has been made, based on the allocation table and the translation table, and performing erasure processing on the specified physical sector.

10. The disk array control method according to claim 9, wherein
in response to the write request with respect to the logical disk, specifying the logical disk registered in the under-erasure table, specifying a physical sector allocated to the logical sector in the logical disk based on the allocation table and the translation table, and allocating the specified physical sector to a logical sector which becomes a new writing target area in response to the write request.
